(19) United States
(12) Patent Application Publication
(10) Pub. No.: US 2014/0178717 A1
(43) Pub. Date: Jun. 26, 2014

(54) BATTERY PACK

(71) Applicant: Samsung SDI Co., Ltd., Yongin-si (KR)

(72) Inventor: Sang-Joo Lee, Yongin-si (KR)

(73) Assignee: Samsung SDI Co., Ltd., Yongin-si (KR)

(21) Appl. No.: 14/097,229

(22) Filed: Dec. 4, 2013

Related U.S. Application Data
(60) Provisional application No. 61/746,027, filed on Dec. 26, 2012.

(51) Int. Cl. H01M 10/42; H01M 2/04; H01M 2/30; H01M 2/02

(52) U.S. Cl. CPC H01M 10/4257; H01M 2/0202; H01M 2/0404; H01M 2/30
USPC 429/7

(57) ABSTRACT

A battery pack includes a bare cell having a groove on a first surface thereof; a protective circuit module on the first surface of the bare cell; and a terminal portion being coupled to the protective circuit module by a coupling, wherein at least a portion of the groove is located to generally correspond to the coupling.

### CROSS-REFERENCE TO RELATED APPLICATION

This application claims priority to and the benefit of U.S. Provisional Application No. 61/746,027, filed on Dec. 12, 2012 in the U.S. Patent and Trademark Office, the entire content of which is incorporated herein by reference.

### BACKGROUND

1. Field

An aspect of the present invention relates to a battery pack.

2. Description of the Related Art

Recently, secondary batteries have been variously used as power sources of portable electronic devices. As portable electronic devices are used in various fields, demands on secondary batteries are rapidly increased. Secondary batteries can be charged/discharged a plurality of times, and accordingly are economically and environmentally efficient. Thus, the use of the battery packs is encouraged.

Because small and light weight electronic devices are desired, small and light weight secondary batteries are also desired. However, since a material such as lithium having high reactivity is provided to the inside of the secondary battery, the small size and light weight of the secondary battery is limited in view of the safety devices of the secondary battery. Accordingly, a variety of studies have been conducted to develop a secondary battery that can provide a small and light weight battery pack while improving the safety of the secondary battery.

### SUMMARY

Embodiments provide a battery pack having improved safety while being in small in size and light in weight by employing a new structure.

According to an aspect of the present invention, there is provided a battery pack, including: a bare cell having an avoidance groove formed therein; a protective circuit module positioned on a top surface of the bare cell; a top case coupled to the bare cell so as to cover the protective circuit module; and a terminal portion extended from the top case and having one side soldered to the protective circuit module, wherein the avoidance groove is formed at a position corresponding to a solder portion formed by soldering the terminal portion to the protective circuit module.

One side of the terminal portion may be soldered to the protective circuit module at a position opposite to the avoidance groove by passing through the protective circuit module.

The solder portion may be spaced apart from the avoidance groove.

The battery pack may further include an insulating member positioned on the avoidance groove.

The other side opposite to the one side of the terminal portion may be exposed to the outside of the top case by an opening formed in the top case.

The terminal portion may be formed in plural numbers.

The avoidance groove may be formed to have a size corresponding to solder portions of the plurality of terminal portions.

The avoidance groove may be configured in plural numbers so that the plurality of avoidance grooves correspond to the solder portions of the plurality of terminal portions, respectively.

The depth of the avoidance groove may be 20% of the thickness of the cap plate of the bare cell.

The battery pack may further include a vent portion formed on a surface adjacent to the surface in which the avoidance groove is formed among the surface of the bare cell.

Coupling grooves may be formed at both sides of the top case, respectively, and coupling grooves may be formed at both sides of the bare cell, respectively. The battery pack may further include a coupling member inserted into the coupling grooves of the top case and the bare cell so that the top case and the bare cell are coupled to each other.

A screw thread may be formed inside the coupling groove, and the coupling member may be a bolt inserted into the coupling grooves of the top case and the bare cell.

Other features and advantages of the present invention will become more fully apparent from the following detailed description, taken in conjunction with the accompanying drawings.

Terms or words used in this specification and claims should not be restrictively interpreted as ordinary meanings or dictionary-based meanings, but should be interpreted as meanings and concepts conforming to the scope of the present invention on the basis of the principle that an inventor can properly define the concept of a term to describe and explain his or her invention in the best ways.

According to the battery pack of the present invention, an avoidance portion is formed in a bare cell so as to correspond to a solder portion formed by soldering a terminal portion to a protective circuit module, so that it is possible to implement the miniaturization of the battery pack while improving the safety of the battery pack by securing a sufficient spacing distance between the solder portion and the avoidance portion.

Further, an insulating member is positioned on the avoidance portion, so that it is possible to more effectively an undesired short circuit between the solder portion and the bare cell.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a perspective view of a battery pack according to an embodiment of the present invention.

FIG. 2 is an exploded perspective view of the battery pack shown in FIG. 1.

FIG. 3 is a sectional view of the battery pack taken along line A1-A1′ of FIG. 1.

FIG. 4 is a sectional view of the battery pack taken along line B1-B1′ of FIG. 1.

FIG. 5 is a sectional view showing a case where an insulating member is further positioned on an avoidance groove of the battery pack shown in FIG. 3.

FIG. 6 is a perspective view of a battery pack according to another embodiment of the present invention.

FIG. 7 is an exploded perspective view of the battery pack shown in FIG. 6.

FIG. 8 is a sectional view of the battery pack taken along line A2-A2′ of FIG. 6.

FIG. 9 is a sectional view of the battery pack taken along line B2-B2′ of FIG. 6.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

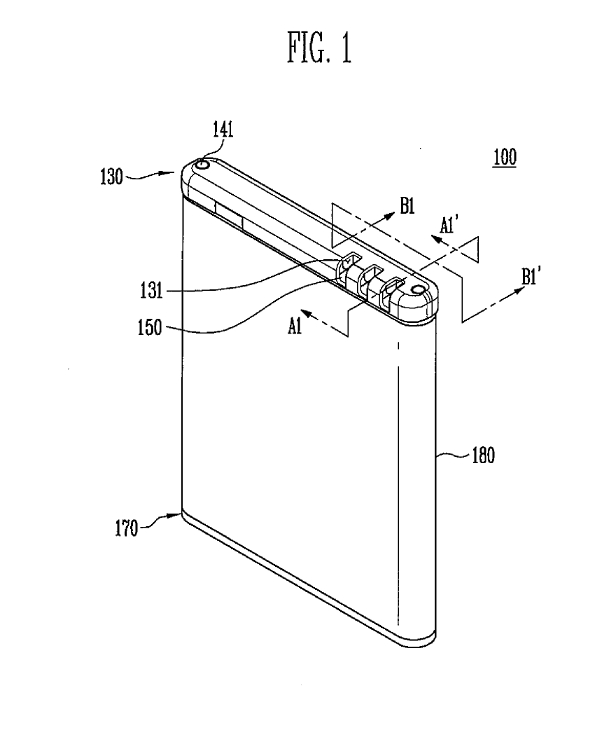

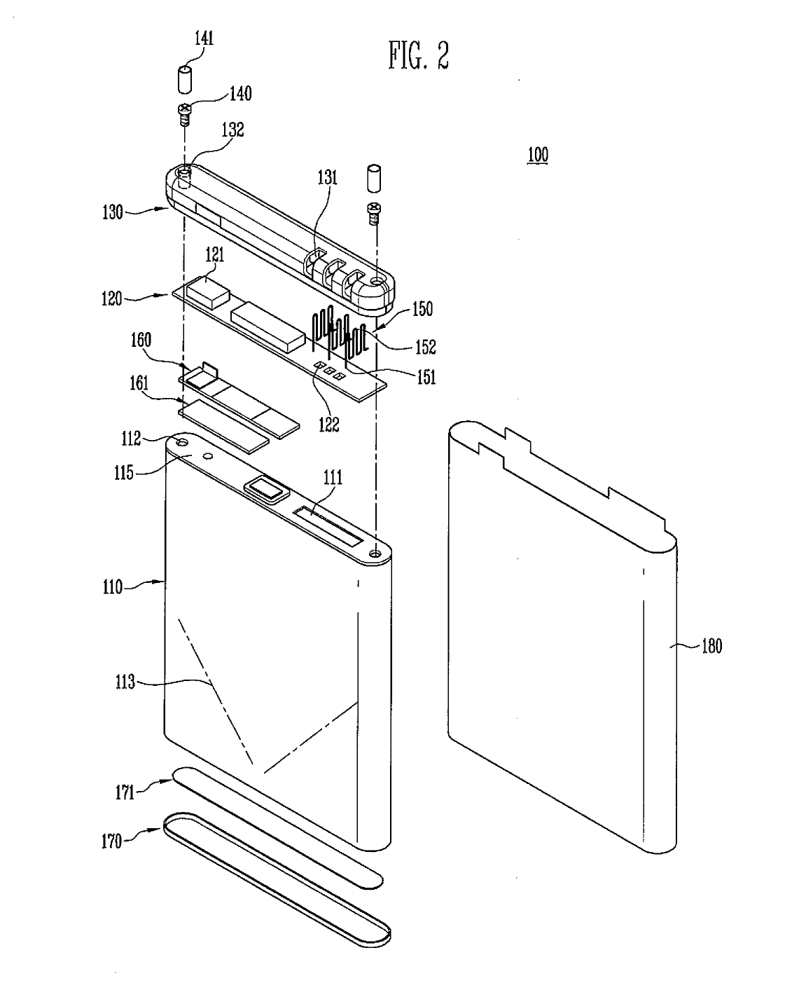

FIG. 1 is a perspective view of a battery pack 100 according to an embodiment of the present invention. FIG. 2 is an exploded perspective view of the battery pack 100 shown in FIG. 1. Hereinafter, the battery pack 100 according to this embodiment will be described with reference to FIGS. 1 and 2.

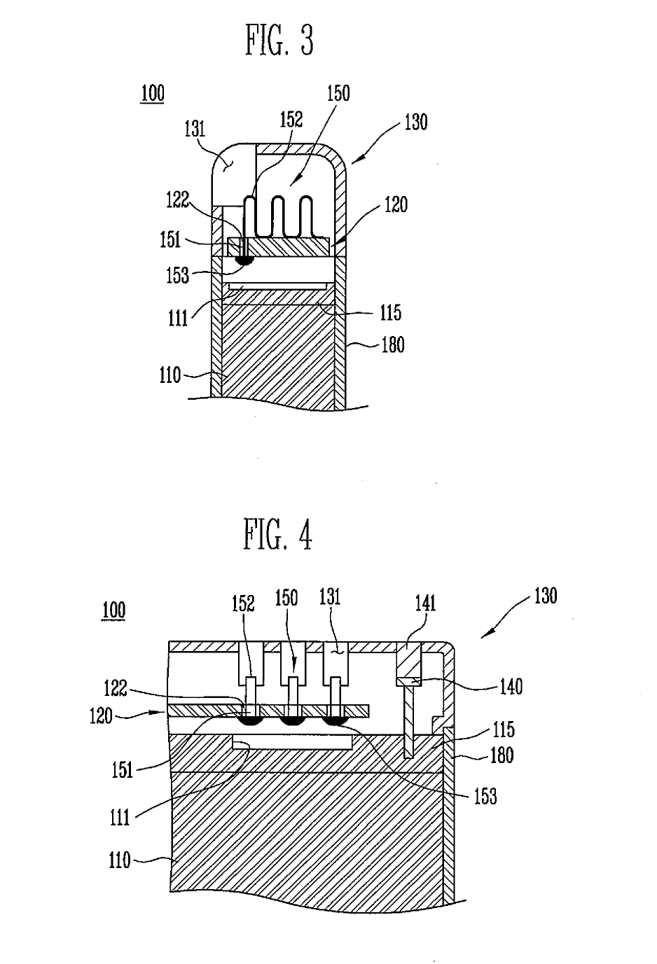

As shown in FIGS. 1 and 2, the battery pack 100 according to this embodiment includes a bare cell 110 having an avoidance groove 111 formed therein, a protective circuit module 120, a top case 130 covering the protective circuit module 120, and a terminal portion 150 coupled to the protective circuit module 120, for example, by soldering. The avoidance groove 111 may be formed at a position generally corresponding to a solder portion 153 (see FIGS. 3 and 4) formed by soldering the terminal portion 150 the protective circuit module 120.

The bare cell 110 is a member that generates electrochemical energy through the movement of ions or electrons.

The bare cell 110 may be manufactured by accommodating an electrode assembly together with an electrolyte in a battery case. Here, the electrode assembly is formed by winding a positive electrode plate, a negative plate and a separator therebetween. The electrode assembly generates energy by an electrochemical reaction between the electrode assembly and the electrolyte, and the energy is supplied to the outside of the electrode assembly through an electrode tab, etc. For example, the battery case may be a pouch-type, prism-type or cylinder-type battery case.

The avoidance groove 111 may be formed in one surface of the bare cell 110. Here, the avoidance groove 111 may be formed in one surface of the bare cell 110 opposite to the protective circuit module 120. The avoidance groove 111 may have a shape recessed from one surface of the bare cell 110.

A vent portion 113 may be further provided as a safety means in the bare cell 110. Here, the vent portion 113 serves as a passage along which gas generated inside the bare cell 110 is exhausted to the outside of the bare cell 110. The vent portion 113 may be formed on a surface adjacent to the surface in which the avoidance groove 111 is formed with respect to the surfaces of the bare cell 110. If the vent portion 113 is formed in a linear shape as shown in FIG. 2, the vent portion 113 may be positioned on a wide or planar surface of the side surfaces of the bare cell 110, but it will be appreciated that the shape of the vent portion is not limited to those shown herein.

The protective circuit module 120 is a member positioned on the bare cell 110 to control voltage or current in charging and discharging of the bare cell 110.

The protective circuit module 120 may be implemented as a circuit board having a circuit pattern formed thereon, and several electronic components 121 may be mounted on one surface of the protective circuit module 120. Here, the electronic components 121 may be a field effect transistor (FET), an integrated circuit (IC), among others. The electronic components 121 may perform a function of controlling the electrode assembly in the bare cell 110 or cutting off a circuit in an abnormal operation of the electrode assembly. The circuit board of the protective circuit module 120 may include a switching circuit to more efficiently control or protect the battery pack 100 together with the electronic components 121. Specifically, the protective circuit module 120 prevents overcharge, overdischarge, overcurrent, reverse voltage, etc., so that it is possible to prevent the explosion, overheating and liquid leakage of the battery pack 100 and the deterioration of charging/discharging characteristics of the battery pack 100. Further, the protective circuit module 120 prevents the degradation of electrical performance and the abnormal operation of the battery pack 100, so that it is possible to eliminate risk factors and to extend the lifespan of the battery pack 100.

The protective circuit module 120 may be positioned opposite to the surface of the bare cell 110, in which the avoidance groove 111 is formed. An opening 122 may be formed in the protective circuit module 120, and one side 151 of the terminal portion 150 may penetrate the protective circuit module 120 through the opening 122.

The top case 130 is a member coupled to the bare cell 110 so as to cover the protective circuit module 120.

The top case 130 may be positioned to be coupled to the surface of the bare cell 110 in which the avoidance groove 111 is formed. Thus, the avoidance groove 111, the protective circuit module 120 and the like are not exposed to the outside of the battery pack 100 by the top case 130. In one embodiment, an opening 131 may be formed in the top case 130, and the other side 152 of the terminal portion 150 may be exposed to the outside of the top case 130 through the opening 131. In this case, the opening 131 may be implemented as a plurality of openings according to the number of terminal portions 150. For example, in a case where the terminal portion 150 is configured with three terminal portions, the opening 131 may also be configured with three openings.

The top case 130 may be coupled to the bare cell 110 through a coupling member 140. In this case, coupling grooves 112 may be formed at both sides of the bare cell 110, respectively, and coupling grooves 132 may be formed at both sides of the top case 130. The coupling grooves 112 and 132 are located at positions corresponding to each other. The coupling member 140 is inserted into the coupling grooves 112 and 132 so that the bare cell 110 and the top case 130 can be coupled to each other. For example, a screw thread may be formed inside the coupling grooves 112 and 132, and the coupling member 140 may be implemented as a bolt to be screw-coupled in the coupling grooves 112 and 132. In one embodiment, a bonding member 141 covering a head portion of the coupling member 140 so that the coupling member 140 is not exposed to the outside may further be positioned at an upper portion of the coupling member 140.

The terminal portion 150 is a member that allows the battery pack 100 and an external device to be electrically connected therethrough.

The terminal portion 150 may be positioned on the one surface of the protective circuit module 120, and the one side 151 of the terminal portion 150 may be soldered to the other surface of the protective circuit module 120 by passing through the opening 122 of the protective circuit module 120. In this case, the one side 151 of the terminal portion 150 may be extended toward the avoidance groove 111 by passing through the opening 122 of the protective circuit module 120. The one side 151 of the terminal portion 150 may be positioned to be spaced from the avoidance groove 111. The one side 151 of the terminal portion 150 may be soldered to the other side of the protective circuit module 120 so as to be electrically connected to the circuit pattern formed on the other surface of the protective circuit module 120.

The terminal portion 150 may be configured as a plurality, e.g., three portions. The one side 151 of the terminal portion 150 may be connected to the protective circuit module 120 through soldering, and the other side 152 of the terminal portion 150 may be exposed to the outside through the opening 131 formed in the top case 130. Thus, the external device can be connected to terminal portion 150 exposed through the opening 131, so that the battery pack 100 and the external device can be electrically connected to each other.

The shape of the terminal portion shown in these figures is merely an example, and the present invention is not limited thereto. That is, the terminal portion 150 may be implemented in various shapes known in the art.

The battery pack 100 may further include a protective element 160, a bottom case 170, a label 180, etc.

The protective element 160 is a member located between the protective circuit module 120 and the bare cell 110 and configured to cut off current by increasing resistance when temperature increases. In order to perform such a function, the protective element 160 may use, for example, a positive temperature coefficient (PTC) element. The protective element 160 may be connected to the bare cell 110 through a protective element tape 161.

The bottom case 170 is a member coupled to a surface opposite to the surface of the bare cell 110, to which the top case 130 is coupled. The bottom case 170 is used to protect the bare cell 110. In this embodiment, the bottom case 170 may be coupled to the bare cell 110, for example, through an adhesive member 171.

The label 180 is a member that surrounds the side surface of the bare cell 110 to which the top case 130 and the bottom case 170 are coupled, so that it is possible to enhance the coupling among the top case 130, the bottom case 170 and the bare cell 110 and to protect the bare cell 110 from the outside. In this case, information on the battery pack 110, a manufacturer and the like may be recorded on the label 180.

FIG. 3 is a sectional view of the battery pack 100 taken along line A1-A1′ of FIG. 1. FIG. 4 is a sectional view of the battery pack 100 taken along line B1-B1′ of

FIG. 1. Hereinafter, the relationship between the avoidance groove 111 and the solder portion 153 in the battery pack 100 according to this embodiment will be described in detail with reference to FIGS. 3 and 4.

As shown in FIGS. 3 and 4, the one side 151 of the terminal portion 150 may be soldered to the other surface of the protective circuit module 120 by passing through the opening 122 of the protective circuit module 120. The solder portion 153 having the terminal portion 150 soldered thereto may be implemented to protrude from the other surface of the protective circuit module 120. Accordingly, the solder portion 153 is positioned on the other surface of the protective circuit module 120, and thus can be spaced from the avoidance groove 111 in the state in which the solder portion 153 is opposite to the avoidance groove 111 formed at a position corresponding to the solder portion 153.

Since the solder portion 153 is implemented to protrude from the other surface of the protective circuit module 120, the solder portion 153 may come into direct contact with the bare cell 110 due to an external impact, etc. Therefore, a sufficient separate space may be formed between the solder portion 153 and the bare cell 110 to reduce the likelihood of such direct contact. Generally, the height of the separate space between the solder portion 153 and the bare cell 110 may be about 1.1 mm. However, as the separate space between the solder portion 153 and the bare cell 110 increases, the size of the battery pack 100 may increase. If the size of the battery pack 100 does not increase, the size of the bare cell 110 is relatively decreased, and therefore, the capacity of the battery pack 100 may be reduced. Accordingly, a sufficient space between the solder portion 153 and the bare cell 110 while being able to maintain the entire size of the battery pack 100 and the capacity of the bare cell 110 is desired.

In this embodiment, the avoidance groove 111 is formed in the bare cell 110 to provide additional space without increasing a size of the battery pack 100. Specifically, if the avoidance groove 111 is formed at the position generally corresponding to the solder portion 153, a relatively large interval between the solder portion 153 and the bare cell 110 can be ensured, so that it is possible to decrease the possibility that the solder portion 153 and the bare cell 110 will come in contact with each other. Since the interval between the solder portion 153 and the bare cell 110 except at the avoidance groove 11 can be narrowed, there is no concern that the entire size of the battery pack 100 increases, and the capacity of the bare cell 110 can be maintained. In this case, the depth of the avoidance groove 111 may be about 20% of the thickness of the cap plate 115. For example, if the thickness of the cap plate 115 is about 1 mm, the depth of the avoidance groove 111 may be about 0.2 mm.

In this embodiment, the terminal portion 150 may be implemented as a plurality, and the solder portion 153 may also be implemented as a plurality. Therefore, the solder portion may be positioned at the one side 151 of each terminal portion 150. The avoidance groove 111 may be implemented to have a size generally corresponding to all of the plurality of solder portions 153. For example, when the solder portion 150 is configured with three solder portions, the avoidance groove 111 may be implemented to have a size capable of generally corresponding to all three solder portions 153. Thus, any solder portion 153 can be sufficiently spaced from the bare cell 110 by the avoidance groove 111.

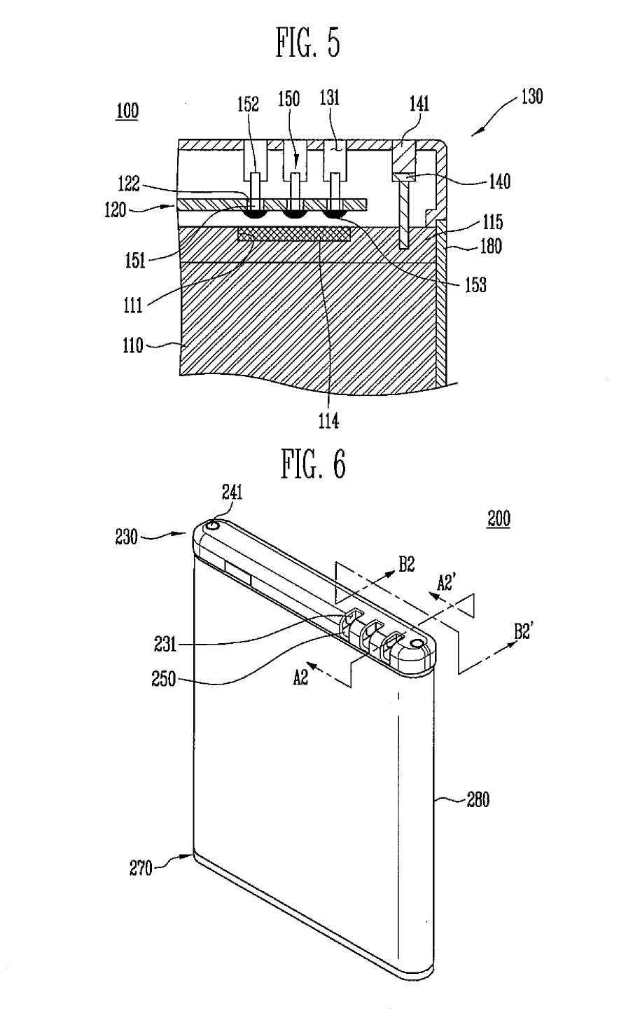

FIG. 5 is a sectional view showing a case where an insulating member 114 is further positioned on the avoidance groove 111 of the battery pack 100 shown in

FIG. 3.

Referring to FIG. 5, the insulating member 114 may be further positioned on the avoidance groove 111, and accordingly, it is possible to more effectively prevent a short circuit between the terminal portion 150 and the bare cell 110. In this case, the insulating member 114 may be, for example, a single-faced or double-face tape, and the width of insulating member 114 may be narrower than the avoidance groove 111.

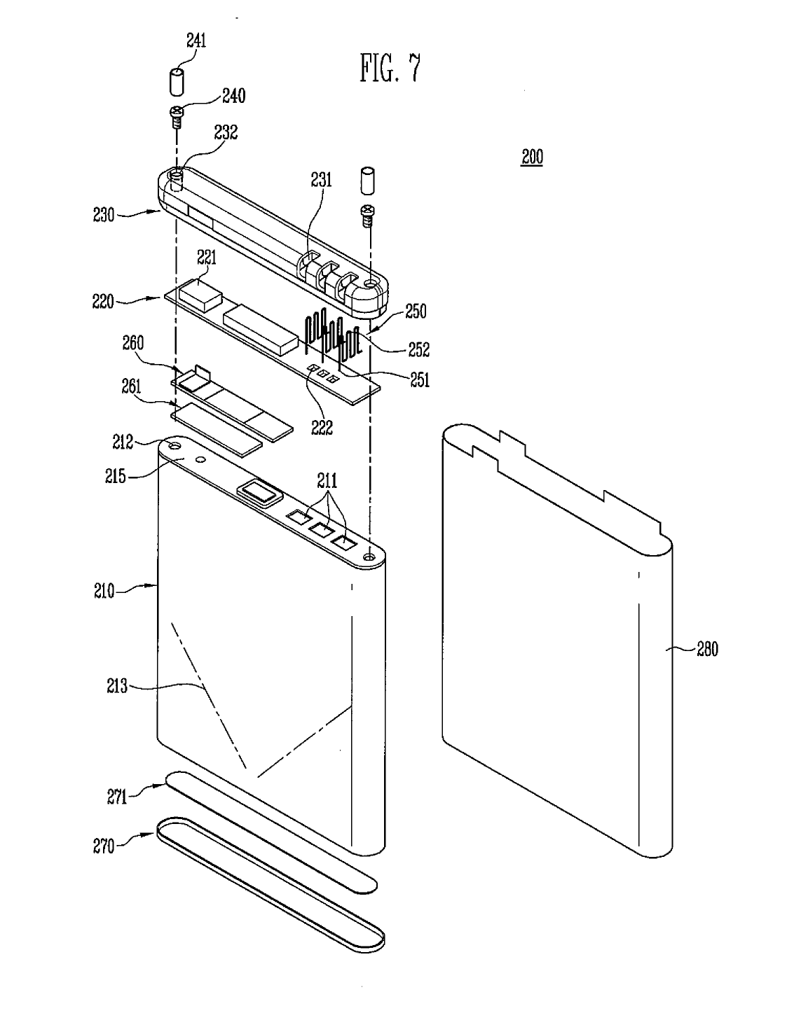

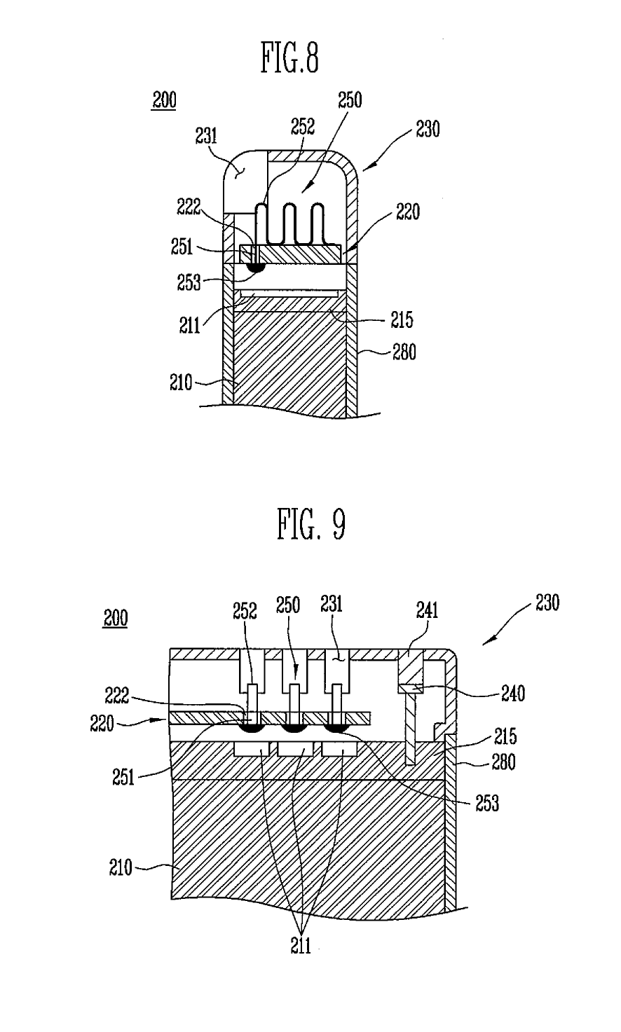

FIG. 6 is a perspective view of a battery pack 200 according to another embodiment of the present invention. FIG. 7 is an exploded perspective view of the battery pack 200 shown in FIG. 6. FIG. 8 is a sectional view of the battery pack 200 taken along line A2-A2′ of FIG. 6. FIG. 9 is a sectional view of the battery pack 200 taken along line B2-B2′ of FIG. 6.

Hereinafter, the battery pack 200 according to this embodiment will be described in detail with reference to FIGS. 6 to 9. The battery pack 200 according to this embodiment includes a bare cell 210 having an avoidance groove 211 formed therein, a protective circuit module 220, a top case 230 covering the protective circuit module 220, and a terminal portion 250 soldered to the protective circuit module 220. The avoidance groove 111 may be formed as a plurality, and the plurality of avoidance grooves may be respectively formed at positions generally corresponding to solder portions 253 (see FIGS. 8 and 9) formed by soldering the terminal portion 250 to the protective circuit module 220.

Accordingly, the avoidance groove 211 of the battery pack 200 according to this embodiment is not implemented as one large avoidance groove, like the avoidance groove 111 shown in FIG. 2, but implemented as a plurality so that the plurality of avoidance grooves generally correspond to the plurality of solder portions 253, respectively. For example, in a case where the solder portion 253 is configured with three solder portions, the avoidance groove 211 may also be configured with three avoidance grooves so that the avoidance grooves correspond to the respective solder portions 253. In this embodiment, when the avoidance grooves 211 are located to correspond to the respective solder portions 253, the alignment reference can be set when the top case 230 is mounted to the bare cell 210, in addition to the prevention of a short circuit between the solder portion 253 and the bare cell 210, the prevention of an increase in the size of the battery pack 100, and the prevention of a decrease in the capacity of the bare cell 210. Specifically, since the avoidance grooves are implemented to generally correspond to the respective solder portions 253, the top case 230 can be aligned on the bare cell 210 so that the avoidance grooves 211 are positioned below the respective solder portions 253 when the top case 230 is mounted to the bare cell 210. Subsequently, a coupling member 240 is inserted into coupling grooves 212 and 232, so that the top case 230 and the bare cell 210 can be easily coupled to each other.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A battery pack comprising:
a bare cell having a groove on a first surface thereof;
a protective circuit module on the first surface of the bare cell; and
a terminal portion being coupled to the protective circuit module by a coupling, wherein at least a portion of the groove is located to generally correspond to the coupling.

2. The battery pack of claim 1, wherein the coupling comprises a solder portion.

3. The battery pack of claim 1, wherein the protective circuit module has an opening generally corresponding to a location of the terminal portion.

4. The battery pack of claim 3, wherein the terminal portion extends into the opening.

5. The battery pack of claim 3, wherein the opening comprises a plurality of openings.

6. The battery pack of claim 1, wherein the groove is spaced from the coupling.

7. The battery pack of claim 1, further comprising an insulating member in the groove.

8. The battery pack of claim 7, wherein the insulating member comprises single-sided tape or double-sided tape.

9. The battery pack of claim 1, wherein the bare cell comprises a cap plate, and wherein the groove has a depth of about 20% of a thickness of the cap plate.

10. The battery pack of claim 9, wherein the groove is on the cap plate.

11. The battery pack of claim 1, wherein the groove comprises a plurality of grooves.

12. The battery pack of claim 11, wherein the coupling comprises a plurality of couplings and wherein each of the grooves generally corresponds to at least a portion of a respective one of the couplings.

13. The battery pack of claim 1, further comprising a vent portion located on a second surface of the bare cell, the second surface being adjacent to the first surface.

14. The battery pack of claim 1, further comprising a top case covering the protective circuit module.

15. The battery pack of claim 14, wherein the top case has coupling grooves configured to receive a coupling member.

16. The battery pack of claim 14, further comprising a coupling member in each of the coupling grooves coupling the top case and the bare cell together.

17. The battery pack of claim 14, wherein the top case has an opening and wherein the terminal portion is exposed through the opening.

18. The battery pack of claim 1, wherein the coupling protrudes from the protective circuit module towards the groove.
